(19) United States
(12) Patent Application Publication
(10) Pub. No.: US 2013/0256965 A1
(43) Pub. Date: Oct. 3, 2013

(54) Clamping and Positioning Modules and Related Clamping Devices for Clamping Sheet Metal Components

(71) Applicant: TRUMPF LASER-UND SYSTEMTECHNIK GMBH, Ditzingen (DE)

(72) Inventors: Valentin Haag, Stuttgart (DE); Maximilian Merk, Renningen (DE)

(73) Assignee: Trumpf Laser-und Systemtechnik GmbH, Ditzingen (DE)

(21) Appl. No.: 13/854,468

(22) Filed: Apr. 1, 2013

(30) Foreign Application Priority Data
Mar. 30, 2012 (DE) 102012102820.6

(51) Int. Cl. B23K 37/04; B23Q 3/06; B23Q 1/03

(52) U.S. Cl. CPC B23K 37/04; B23Q 1/037; B23Q 3/06
USPC 269/55; 269/216; 269/221; 269/100

(57) ABSTRACT

A clamping module for a clamping device with a housing which accommodates a drive device which transfers at least one clamping jaw from a starting position to a clamping position, wherein at least one solid body joint is provided between the drive device and the at least one clamping jaw, the solid body joint being elastically resilient in the direction of a clamping movement of the clamping jaw. A clamping device comprises at least one clamping module and/or a positioning module.

### CROSS REFERENCE TO RELATED APPLICATION

Under 35 U.S.C. §119, this application claims the benefit of a foreign priority application filed in Germany, serial number 10 2012 102 820.6, filed on Mar. 30, 2012, the entire contents of which are hereby incorporated by reference.

### TECHNICAL FIELD

The invention relates to clamping and positioning modules and related clamping devices for clamping sheet metal components.

### BACKGROUND

A welding device for the welding of several sheet metal blanks to a tailored blank is known from DE 100 29 293 A1. Such a welding device includes a mounting frame upon which sheet metal blanks are placed. The end edges assigned to one another form the welding edges, which are cohesively connected to one another by a welding operation. To this end a series of clamping devices is arranged above the mounting frame, the series of clamping devices generating a path generation with a pressure cylinder for transferring the respective clamping jaw to a clamping position. Due to the plurality of circular clamping jaws arranged next to one another any ripples of the sheet metal blank will be flattened, so that the welding edges come to rest flush. Subsequently, a seam is welded with a welding device to connect the sheet metal blanks to one another.

This welded joint only facilitates the connection of sheet metal blanks, that is, plane sheet metal components. Additional sheet metal components with a shape deviating from a plane sheet form cannot be welded to one another. In addition, the design effort of such a device is cost intensive.

### SUMMARY

In one aspect of the invention, a clamping module for a clamping device includes at least one path generation device in a housing which can be supplied with stroke, wherein between the path generation device and the at least one clamping jaw at least one solid body joint is provided which is elastically yielding in the direction of the clamping movement. However, in a range of deflection of the clamping movement a nearly unchanged clamping force transfers. Thus, through the clamping module a clamping force can be generated which remains nearly constant in the range of deflection. At the same time the at least one clamping jaw can contact the component, that is, there is a nearly complete or a full contact of the at least one clamping jaw on the component. In addition, as a result it is possible that in the case where a shifting of the component onto an accommodating pin of a clamping device (against which the forcing clamp acts) is supposed to occur in the event of the unclamping of the component, that this shifting only takes place in the direction of a joint edge to prevent the development of a gap between the two sheet metal components to be assigned to one another. The surface contact of the clamping jaw also serves the purpose of heat transfer in the form of heat conduction from the component to the clamping jaw. Independently, the at least one solid body joint makes possible a nearly unchanged clamping force along the weld seam regardless of the sheet thicknesses of the component that are to be clamped.

The housing can additionally have a mechanism (e.g., a lever mechanism), which can be supplied with stroke through the path generation element. This makes possible the generation of a great clamping force with a relatively compact path generation element through the leverage ratios. The at least one solid body joint is provided between the at least one (lever) mechanism and the at least one clamping jaw, the solid body joint being elastically yielding in the direction of the clamping movement, however in a range of deflection of the clamping movement transfers a nearly unchanged clamping force. The at least one solid body joint can be designed rigid in at least one direction of movement transverse to the clamping movement. As a result the elastic flexibility will be limited only in or along the clamping movement, so that a defined and secure application of a clamping force is possible.

The lever mechanism of the clamping module can include at least one connecting or push rod and one clamping lever which are connected to one another in a hinged manner. In the case of a slight angular deflection among other things a solid body joint or a flexurally elastic connecting rod can serve as a joint. The at least one clamping jaw can be arranged on the free end of the clamping lever. The clamping lever is typically rotatable around a stationary, pivoting axis arranged on the base body of the clamping module or supported in an unrolling movement. The support can also take place by an alternative design with the same mode of operation, for example with a sliding and pivoting mechanism. As a result, a construction of a clamping module simple in design can be achieved for the generation of a sufficient clamping force via the clamping lever, which is constructed as a lever arm.

The path generation element can be positioned between lever mechanisms arranged at a distance to one another. The path generation element actuates the lever mechanisms which engage the at least one clamping jaw. Through the double design of the lever mechanism the application of force (e.g., on only one common clamping jaw) can take place away from a center of the clamping jaw, as a result of which there can be a more uniform application of the clamping force on the sheet metal part. In addition, a linear or areal application of force is possible via the clamping jaw. The path generation element can also directly engage the clamping lever.

The at least one clamping jaw can be arranged exchangeably, (e.g., by a snap, tension, snap-on or clamped connection) on the at least one lever mechanism. Due to the rapid exchangeability of the clamping jaw on the clamping module a custom adaptation can take place in the form of the clamping jaw on the component to be clamped. For example, an adjustment to the length of the jaw or a cutting away of contours in the clamping jaw in the case of components that are not plane, such as welded studs or the like. Through the snap, tension, snap-on or clamped connection the clamping jaw is not only exchangeable, but rather is also adjustable in distance to the joint edge.

The solid body joint can be arranged in one piece on a clamping lever of the lever mechanism. As a result a component-reduced design is possible.

As an alternative, the solid body element can be arranged via a snap, tension, snap-on or clamped connection on a clamping lever by analogy to such a connection arranged on the clamping jaw. As a result, depending on the application solid body joints with different rigidities and/or a clamping stroke can be selected and provided depending on the clamping force to be applied.

A reset element can engage the lever mechanisms and/or the path generation element to reset element the lever mechanisms to a starting position in a non-impacted state of the path generation element. The clamping jaw is raised to this starting position vis-à-vis the accommodating pin, so that a simple removal of the joined component and a fitting with a further sheet metal component are possible. In addition, a power supply to the path generation element is only necessary to generate a lifting movement for a clamping operation. The reset element can be integrated in the path generation element or be separate from it.

The clamping jaw typically has a maximum lift of less than 16 mm for a clamping stroke. In the process, the clamping stroke typically lies below the critical finger-compressive yield point to be able to secure a component while being clamped by hand.

The housing of the clamping module includes a right and left wall section, in each of which a positioning opening is provided for plug-on arrangement on a clamping beam of a clamping device. The wall sections align with one another, and the lever mechanism is guided along at least one exterior of the positioning opening. A single-piece housing is also conceivable. Through this structure of the housing a simple arrangement of the clamping module on the clamping beam by slipping on is possible, since this clamping module is then positively secured to the clamping beam. Great leverage can be applied via the lever mechanism without the leverage impairing the additional functions of the clamping module. In addition, the clamping and/or positioning module can be arranged anywhere along the joint edge. A favorable cross-section profile of the clamping beam is possible, the profile producing a high torsional strength and flexural strength.

In another aspect of the invention, a positioning module for a clamping device includes a housing that accommodates a path generation element and at least one mechanism. The mechanism actuates an alignment element which can be transferred to an alignment position with a sliding-pivoting movement. Such a positioning element serves the purpose of aligning the joint edge of components on an accommodating pin of a clamping device so that an arrangement of the component that is correct in position results for a joint between two components to be clamped to one another. Through the sliding or pivoting movement of the alignment element it can be positioned separately from a clamping module on an accommodating pin and can be adjacently positioned on its housing to align an end edge of a sheet metal part to be aligned. Subsequently, a clamping movement can be performed by at least one clamping jaw of the clamping module independently from the assumed alignment position.

The positioning module can include a mechanism which is constructed as a lever mechanism, e.g. as a knee lever mechanism, which actuates a pivoting and sliding element that is guided in a housing section of the positioning module. Through such a lever mechanism greater lifting movements can be rapidly carried out, wherein in an end position a defined alignment can be set without a clamping force being required to act on an accommodating pin or an adjustable clamping force being required to act on the accommodating pin.

The pivoting and sliding element of the positioning module can be guided longitudinally displaceably in the housing through a slot, wherein the alignment element is movably guided along a further slot of the pivoting and sliding element. The pivoting and sliding element is pivoted on at least one housing section with a fixed pivoting axis. As a result a compact construction can also be achieved.

The positioning element can have in a right and left wall section a positioning opening for plug-on arrangement of the housing on the clamping beam of the clamping device. As a result, this positioning module can be easily placed upon a clamping beam and can be moved along the clamping beam for maintenance of a desired position by simple movement. In addition, typically the positioning opening of the positioning module can at least positively engage the clamping beam so that in the event of the transfer of the alignment element to a working position simultaneously a fixing in position of the positioning module to the clamping beam takes place along its longitudinal axis.

A modular constructed clamping device includes a base plate on which an accommodating pin and at least two clamping beams can be arranged freely projecting and the at least two clamping beams and the accommodating pin are positioned in a triangular position to one another. At each clamping beam at least one clamping module can be arranged and to which at least one clamping jaw of the clamping module arranged thereupon is assigned to the accommodating pin for the fixing of a sheet metal component. Such a clamping device makes possible the accommodation of a plurality of sheet metal components differing from one another, to weld their linear welding edges of the sections of one or more components assigned to one another. The clamping device is designed simply and formed by the clamping beams and the accommodating pin, the clamping beam and accommodating pin being able to differ in size, shape or length to make possible a flexible and cost-effective as well as simple refitting to the subsequent welding operation. Such a clamping device presents an easily adjustable welding device for model and prototype construction as well as for single item or batch production, and is applicable also to full-scale production. As a result, a broad range of different sheet metal components with different joint geometry and seam types can be welded to one another. The use of the clamping device is independent from the respective welding method; however, due to the high positioning and repetitive accuracy it is particularly well suited for laser welding.

This clamping device also has the advantage that it can be set up in a welding cell (for example the TruLaser Robot 5020 of the applicant) stationary or at an unused place in the workspace as well as also separately from existing component positioners. Thus by correspondingly retrievable subroutines at a parallel running full-scale production components can be clamped and welded with the clamping device without in the process having to take down the parts in serial production or the welding bodies from the component positioner currently being used.

The clamping modules can be arranged in a mirror image to the accommodating pin on the clamping beams so that the clamping jaws of the clamping modules with the formation of a gap fix at least two welding edges of sheet metal parts facing one another with one joining edge to the accommodating pin. Through the triangular arrangement of the clamping beams and of the accommodating pin as well as the mirror image arrangement of the clamping modules on the clamping beams an optimum clamping force is made possible for fixing the sheet metal components on the accommodating pin as well as there being a good accessibility to the welding edges of the sheet metal component or components for the production of a welding seam.

One or more clamping modules can be arranged on the clamping beam, the clamping modules being accommodated in such a way as to be movable along the clamping beam. As a result the clamping module can be set to the desired clamping position along the clamping beam. Short pipes can be produced even in the case of several clamping modules arranged on a clamping beam, the short pipes for example being manufactured of two or more sheet metal parts.

The housing of the clamping module can be positively and/or non-positively connected to the clamping beam. The positive arrangement of the clamping module on the clamping beam makes possible easy handling by pushing the clamping module onto the clamping beam and independently fixing a location of the clamping module to the clamping beam takes place through a subsequent clamping of the sheet metal component. As an alternative, the clamping module can be placed on the clamping beam and be fixed by a positive and/or non-positive connection (e.g., a tension lock).

The clamping beam advantageously has a cross-sectional geometry which with a complementary opening on the outer periphery in the housing of the clamping module forms an anti-turn accommodation of the clamping module. For example, the clamping beam can have a square or rectangular shaped or also polygon shaped cross-section, wherein the opening in the housing of the clamping module includes an opening corresponding to the cross-section of the clamping beam. After the placement of the clamping module onto the clamping beam a prevention of rotation is ensured. As a result handling is easy.

On the free ends of the clamping beam and of the accommodating pin a strap or a fixture device can be arranged which fixes the distance of the clamping beam and of the accommodating pin in their unloaded state to one another. This fixture device makes it possible that the clamping force applied via the clamping modules for fixing the sheet metal components is also retained; otherwise with increasing freely projecting length of the clamping beams and of the accommodating pin an increasing deflection or bending would result. For example, an insertion section can be provided on two ends of the fixture device, the insertion section being inserted into the cross-section of the clamping beam or engaging on the end section, wherein in a central section of the fixture device an additional fastening element can be provided, the fastening element engaging on the accommodating pin or being insertable therein.

The accommodating pin and/or the at least one clamping beam are typically accommodated in a movable manner along the plane of the base plate. This makes it possible to preset to the sheet metal thickness to be clamped. Additionally, in the case of sheet metal components which have at least one angle of bend a mounting on the accommodating pin can take place before the accommodating pin is transferred to a processing or clamping position in which the clamping jaws of the clamping module of the sheet metal component can clamp to the accommodating pin.

For exact positioning of the clamping jaws and of the accommodating pin to the base plate as well as for the application of the necessary rigidity in a confined space a centering device can be provided between the base plate and the accommodating pin and/or the respective clamping beam. This centering device typically includes centering blocks which have the function of applying the occurring clamping forces and the resulting bending moments to the base plate to relieve the linear guide (linear roller bearing). As a result the necessary rigidity and position of the accommodating pin can be achieved in a confined space. Likewise as a result the deflection of the freely projecting accommodating pin and of the freely projecting clamping beams, which are seated to the left and right of the joint and are fastened to the clamping modules, acts imperceptibly on the clamping force with which the sheet metal component is held.

At least one positioning module can be arranged on the clamping module or the clamping beam, the positioning module being movable along the longitudinal axis of the clamping beam. As a result the sheet metal components can be fixed in a predetermined working position on the accommodating pin for the formation of butts for the welding seam to be formed.

In addition, a stop element can be provided on the clamping beam or on the accommodating pin. This stop element can be movable along the longitudinal axis of the clamping beam or of the accommodating pin and forms a Z stop, that is, a stop in the Z direction. As a result, the immersion depth of the sheet metal component or components can be determined.

Typically at least one auxiliary clamping element can be fastened on the accommodating pin for the accommodation of at least one sheet metal component. Such auxiliary clamping elements can be placed on the accommodating pin as adapter elements to make possible a rapid and easy adjustment to the subsequent welding task or component geometry (e.g., in the event of folded edges and/or seam geometry). In the process the auxiliary clamping elements can have any shape or be integrated into the accommodating pin.

The accommodating pin can have a channel assigned to the welding edge for the supply of a welding gas or a cooling medium. Through the supply of gas (e.g., shielding gas) the quality of the welding seam can be improved for the welding process through a reduced formation of oxide in the weld upper bead. This obviates the need for the subsequent treatment of the welding seam surface for the removal of the seam layer. In addition, a rapid cooling of the component and at least of the accommodating pin is possible.

Advantages include a clamping module and a positioning module for a clamping device as well as a modular constructed clamping device for a welding operation. A high flexibility in use is possible regardless of the joint geometry of the joint edge to produce a weld seam at two welding edges arranged next to one another. In addition, there is a high repetitive accuracy and low setup times.

Further advantageous embodiments and improvements of the same will be described and explained in greater detail in the following with the assistance of the examples presented in the drawings. The features to be gathered from the description and the drawings can be applied inventively either individually or in groups in any combination. The figures show the following:

### DESCRIPTION OF DRAWINGS

FIG. 1 shows a perspective view of a clamping module with a removed front housing wall;

FIG. 2 shows a further perspective view of the clamping module in accordance with FIG. 1;

FIG. 3 shows a perspective view of an alternative embodiment of a clamping module from FIG. 1;

FIG. 4 shows a perspective lateral view of an inventive clamping device with clamping modules in accordance with FIG. 1;

FIG. 5 shows a perspective view of the clamping device according to FIG. 4 with a sheet metal component fastened to it;

FIG. 6 shows a schematic view of the clamping device according to FIG. 5;

FIG. 7 shows a schematic partial section of a clamping position of the clamping modules along the line VI-VI in FIG. 6;

FIGS. 8a and 8b show a schematic detailed representation of the clamping module for the mode of operation of a solid body joint of the clamping module according to FIG. 1;

FIG. 9 shows a schematic overview of a sequence of work steps for clamping accommodation of a component;

FIGS. 10a through 10c show schematic representations of the individual work steps along the line of intersection IX-IX in FIG. 9;

FIG. 11 shows a perspective view of two clamping devices on a work bench for simultaneous clamping of two edges of a container;

FIG. 12 shows a basic representation of two accommodating pins of two clamping devices in accordance with FIG. 11;

FIG. 13 shows a schematic top view in the clamping state of the clamping devices of FIG. 12;

FIGS. 14a through 14c show schematic views of a clamping device for the clamping of tubular components;

FIG. 15 shows a perspective view of a positioning module in a starting position;

FIG. 16 shows a perspective view of the positioning module in accordance with FIG. 15 in an alignment position;

FIG. 17 shows a perspective view of the clamping device according to FIGS. 14a through 14c with the positioning module in accordance with FIG. 17 in the alignment position;

FIGS. 18a and 18b show a schematic sequence of work steps for the positioning of the sheet metal components to one another with the positioning module in accordance with FIG. 15; and

FIG. 19 shows a schematic sectional view along the line XVIII-XVIII in FIG. 18.

### DETAILED DESCRIPTION

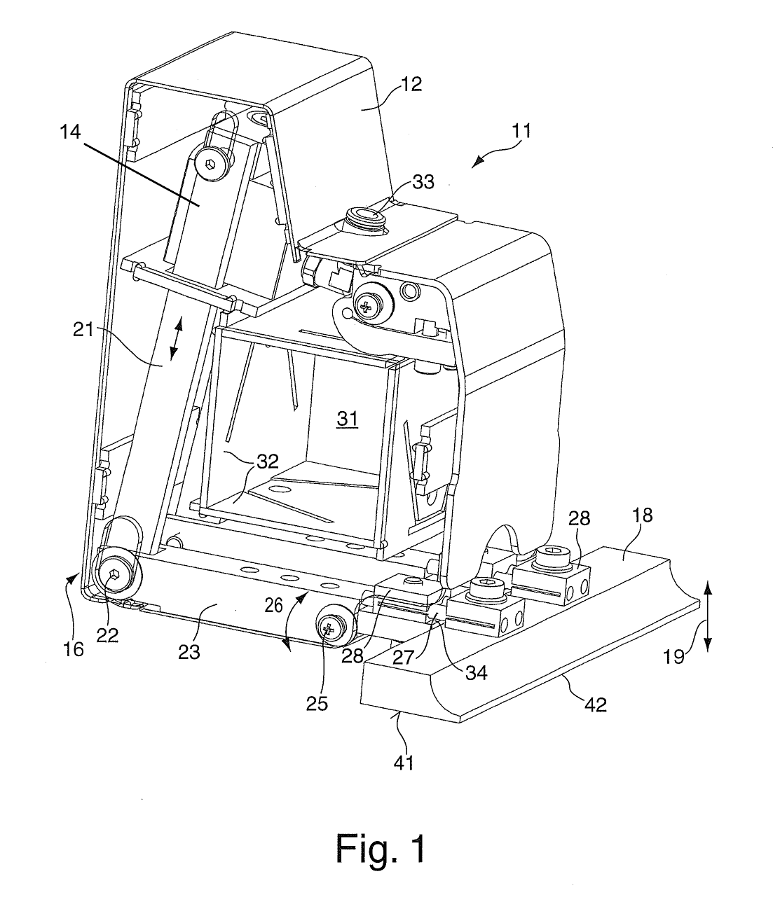

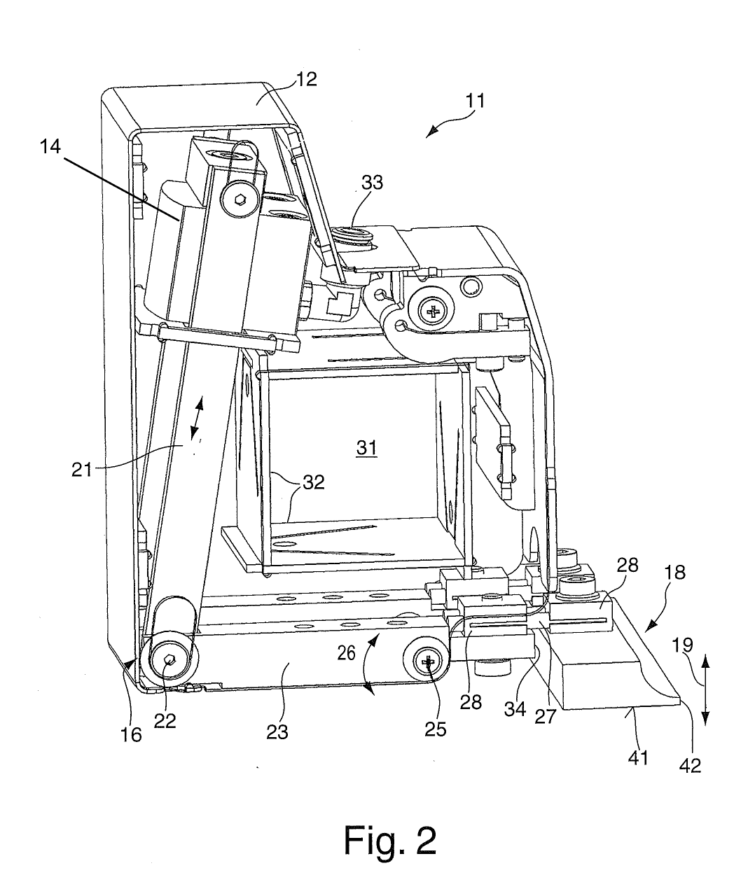

FIGS. 1 and 2 show perspective views of a clamping module 11, wherein a front housing section is removed. This clamping module 11 includes a housing 12, in which a path generation element (drive mechanism) 14 that, via a lever mechanism 16, moves a clamping jaw 18 along a working stroke or clamping stroke up and down (in accordance with clamping direction or arrow 19). The path generation element 14 is stationary in the housing 12. The path generation element 14 typically includes a pneumatic lift cylinder. As an alternative a hydraulic lift cylinder or an electromagnetic drive can be used. A connection 33 is provided on a front side of the housing 12 to which a supply line (e.g., a pneumatic line) can be connected to the path generation element 14.

A push rod or connection rod 21 of the lever mechanism 16 is fastened to the path generation element 14. The push rod or connection rod 21 is connected to a clamping lever 23 via a joint 22. The clamping lever is pivotable around a pivoting axis 25 on the housing 12 in the direction of arrow 26. The clamping lever 23 and the push rod or connection rod 21 form the lever mechanism 16. A solid body joint 27 is arranged between the clamping lever 23 and the clamping jaw 18. In accordance with the first exemplary embodiment a detachable clamping element 28 is connected to both the clamping lever 23 and the clamping jaw 18 for accommodation of the solid body joint 27. As a result the solid body joint 27 is exchangeable and can be adapted to an individual application. In accordance with the first exemplary embodiment the solid body joint 27 is constructed as a spring bar.

Typically two lever mechanisms 16 in parallel arrangement at a distance from one another are arranged for actuation of the clamping stroke 19 of the clamping jaw 18. The path generation element 14 is arranged in a space saving manner lying in between the push rods or connection rods 21 of the lever mechanism 16. Through the parallel actuation of two lever mechanisms 16 a uniformly distributed application of force can take place over the length of the clamping jaw 18.

In addition, a reset element is in the housing 12, by which the lever mechanism 16 is reset from a clamping position back to a starting position. This can for example be a damping element, spring element or the like.

The clamping module 11 additionally has in the central region of the housing 12 a positioning opening 31 which is formed by four wall sections 32 adjacent to a front and rear housing wall so that an interior of the positioning opening 31 is closed off with respect to the mechanically moveable components lying in the housing 12. The positioning opening 31 can be adapted to the geometry of a clamping beam of a clamping device to be described below.

The lever mechanism 16 is arranged in the housing 12 of the clamping module 11 in such a way that it extends outside of the wall sections 32 along the positioning opening 31. The necessary lever arms can simultaneously be provided in a space saving manner, the lever arms being necessary for application of the clamping force. Typically the lever arm between the pivoting axis 25 and the joint 22 is designed to be at least twice as long (e.g., at least three times as long) as the lever arm between the pivoting axis 25 and a free end 34 of the push rod or connection rod 23. As a result, in the case of a slight working stroke of the path generation element 14 a predefined clamping stroke 19 can be achieved, which can be less than 12 mm.

The clamping jaw 18 can be designed to be exchangeable and adaptable to the welding edge of a component. Simultaneously a corresponding material selection for different clamping jaws 18 can take place. Typically the clamping jaw 18 has a clamping surface 41 which extends over the entire surface in the length and width of the clamping jaw 18. In addition, a pointy clamping edge 42 is designed which points to a joint or to a developing welding seam. An opposing region of the clamping jaw 18 is designed rigid in cross-section.

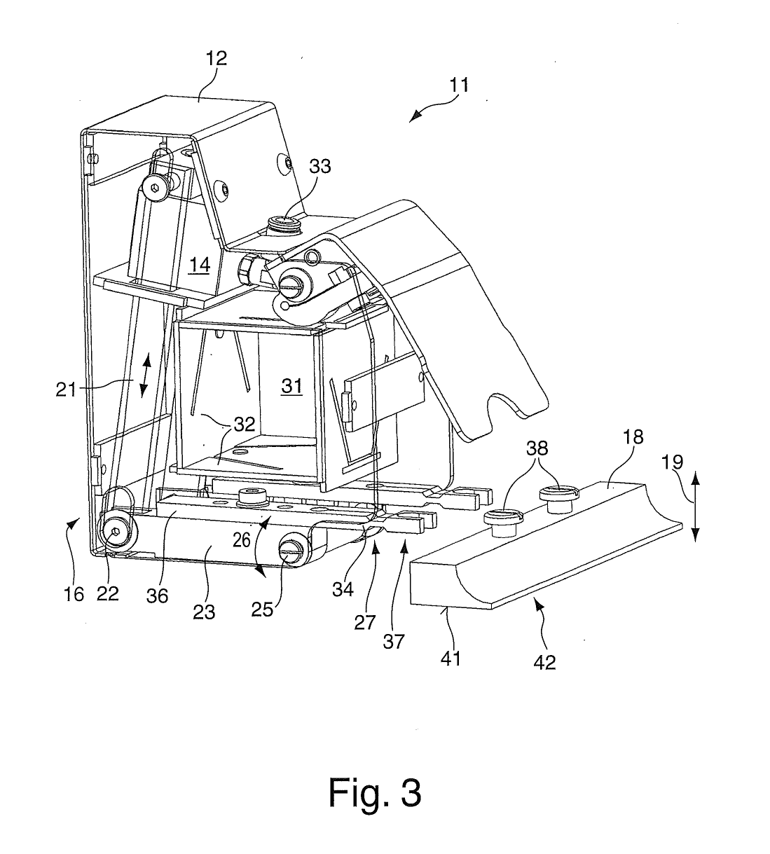

FIG. 3 shows an alternative embodiment to FIGS. 1 and 2. The solid body joint 27 is designed to be rod-shaped in this embodiment with an adjacent fastening section 36 fixing the solid body joint 27 to the clamping lever 23, typically in an exchangeable manner. On the opposite end is a fork-shaped receiver 37 which engages with fastening elements 38 (e.g., screw heads for clamping installation) on the clamping jaw 18. A tapered cross-section is formed between the receiver 37 and the fastening section 36. the tapered cross-section forms the solid body joint 27. This cross-section (for example, rectangular-shaped) is designed to have an elastic resilience in and against the clamping stroke in accordance with arrow 19 while having a greater rigidity in a perpendicular direction, that is in the longitudinal axis of the clamping jaw 18 as well as in the longitudinal axis of the solid body joint 27. In the exemplary embodiment both the receiver 37 and the solid body joint 27 are constructed through two separate beam sections. As a result an expansion of the receiver 37 can take place in the event of the placement onto the fastening elements 38 for a pre-stressed positioning of the clamping jaw 18 to the clamping lever 23.

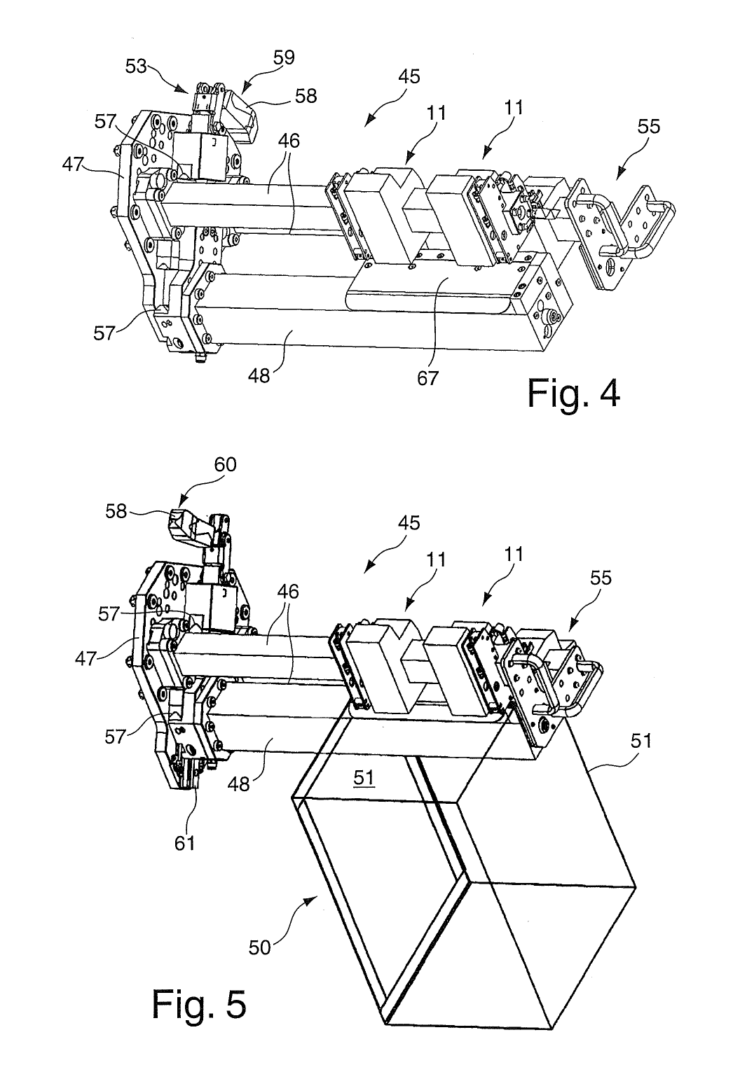

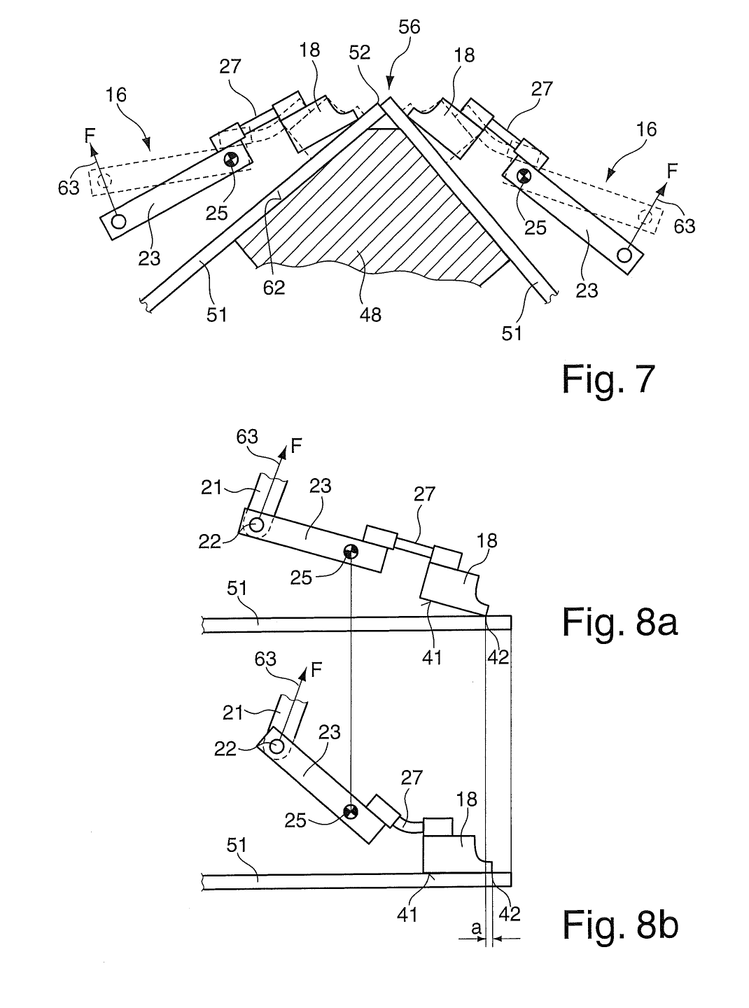

FIGS. 4 and 5 show perspective views of a clamping device 45. This clamping device 45 includes two clamping beams 46, on which the stipulated clamping modules 11 can be placed and moved along their longitudinal axis. These clamping beams 46 are exchangeably fastened on a base plate 47. In addition, an accommodating pin 48 is exchangeably held on the base plate 47. The two clamping beams 46 and the accommodating pin 48 are fastened on one side on the base plate 47 and are in triangular arrangement to one another. As shown in FIG. 5, two components 51 are positioned on the accommodating pin 48 and held tight with the clamping modules 11. These can be two separate components 51 (e.g., metal sheet parts) as shown in FIG. 7 or they can be components 51 which represent parts of a device connected to one another after a forming step (e.g., a container 50).

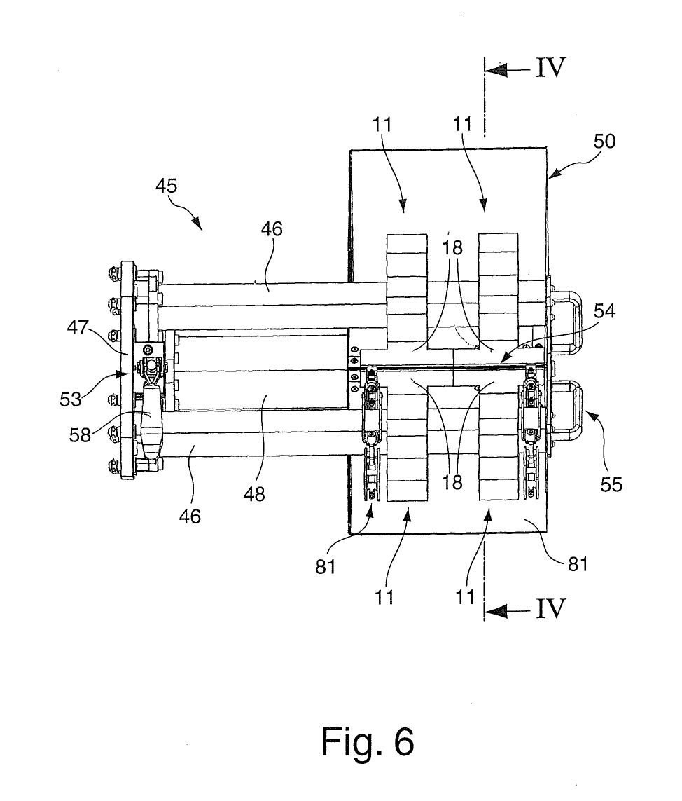

FIG. 6 shows a schematic view of FIG. 5 from above. In this embodiment of the clamping device 45 two clamping modules 11 are on each clamping beam 46. These are each positioned adjacent to a freely projecting end of the clamping beams 48. The clamping modules 11 are in a mirror-imaged arrangement opposite one another so that the clamping jaws 18 form a gap 54. The welding edges of the components 51 assigned to one another through the clamping jaws 18 lie for the formation of a joint to construct a linear welding edge with different seam geometries, such as a butt joint with an I seam, corner joint or T joint or I joint, overlap butt or corner seam.

The clamping jaws 18 typically have a length for the formation of the gap 54 so that in the case of the stringing together of several clamping modules 11 the clamping jaws form a continuous gap 54 along the clamping beams 46. As a result these clamping jaws 18 can serve as an impact wall for the shielding gas fed by a welding process. This leads to a channeling effect of the protective gassing, as a result of which the seam quality is improved through a reduced oxide formation in the weld upper bead. As an alternative or in addition the oxide formation in the weld lower bead can likewise be minimized by a groove perfused with shielding gas in the accommodating pin 48. This can obviate the need for subsequent treatment of the weld seam surface for the removal of an oxide layer.

A mounting device 55 engages on the freely projecting end of the clamping beams 46 and of the accommodating pin 48. The mounting device 55 fastens to the clamping beams 46 and the accommodating pin 48 to fix them at a predetermined distance to each other. The mounting device 55 can be removed from the clamping beams 46 and the accommodating pin 48 or pivoted around one of them so that after application of the clamping modules 11 (and if applicable of the components 51) that in spite of the application of a clamping force via the clamping modules 11 the distance between the clamping beams 46 and the accommodating pin 48 remains constant. This distance is maintained constant in spite of a unilateral clamping of the clamping beams 46 and the accommodating pin 48. As a result, along the longitudinal axis of the accommodating pin 48, along which the linear welding edge runs, uniform clamping conditions for the fixing of the sheet metal components 51 is possible.

The clamping beams 46 and the accommodating pin 48 are attached to the base plate 47 via a centering device 53. This centering device 53 makes it possible to move the clamping beams 46 relative to the accommodating pin 48 or relative to one another to set a greater distance for fitting the sheet metal component 51. In addition the centering device 53 includes so-called centering blocks 57 (best seen in FIGS. 4 and 5) which are fastened on the base plate 47, the centering blocks 57 engaging one another in a clamped state. As a result, the occurring clamping forces and resulting bending moments can be applied in secure manner to the base plate 47 and a greater rigidity can be developed. A clamping lever 58 actuates the centering device 53, the clamping lever being transferable from an opening position 59 shown in FIG. 4 to a closing position 60 shown in FIG. 5. In the exemplary embodiment provision is made that the accommodating pin 48 is lowered along a guide 61.

The arrangement of the clamping beams 46 and of the accommodating pin 48 on the base plate 47 has the advantage that they can be fastened to a predefined perforation to modular systems already employed in welding technology such as work benches or the like.

A clamping operation of two clamping modules 11 facing one another for assignment of two components 51 facing one another to joint 56 will be described below. First, the left component 51 is positioned and held at a support surface 62 of the accommodating pin 48. Then the path generation element 14 is pressurized with compressed air so that a pivoting movement of the clamping lever 23 is applied in the direction of the arrow 63 around the stationary pivoting axis 25. The clamping jaw 18 engages first with its clamping edge 42 on the component 51. This first clamping state is represented with solid lines. After that an additional clamping force is applied via the path generation element 14, so that the clamping lever 23 is moved to the position shown in dashed lines. This results in the solid body joint 27 being deflected in an elastically resilient manner, wherein the clamping surface 41 of the clamping jaw 18 contacts the surface of the component 51 and comes to rest so that at least one linear (e.g., full) contact is given.

The right component 51 is then positioned to the front face 52 of the component 51 to form a butt or the joint 56 for the welding seam. The right clamping module 11 is analogously subjected to a clamping force.

As an alternative, both components 51 can be positioned simultaneously to the accommodating pin 48 and then the left and right clamping modules 11 can be impacted simultaneously or in time delayed manner.

The solid body joint 27 is elastically resilient in clamping direction 19 and is mechanically rigid at least in one transverse direction to the clamping direction, typically in both transverse directions. This arrangement has the advantage that proceeding from the first clamping phase in accordance with FIG. 8a to an end phase in accordance with FIG. 8b requires only a shifting of the component 51 in the direction of the joint 56, as shown by the distance a in FIG. 8b, to prevent the development of a gap. The solid body joint 27 can as an alternative to the bending rod also be constructed as a flat spring element or as a profiled element.

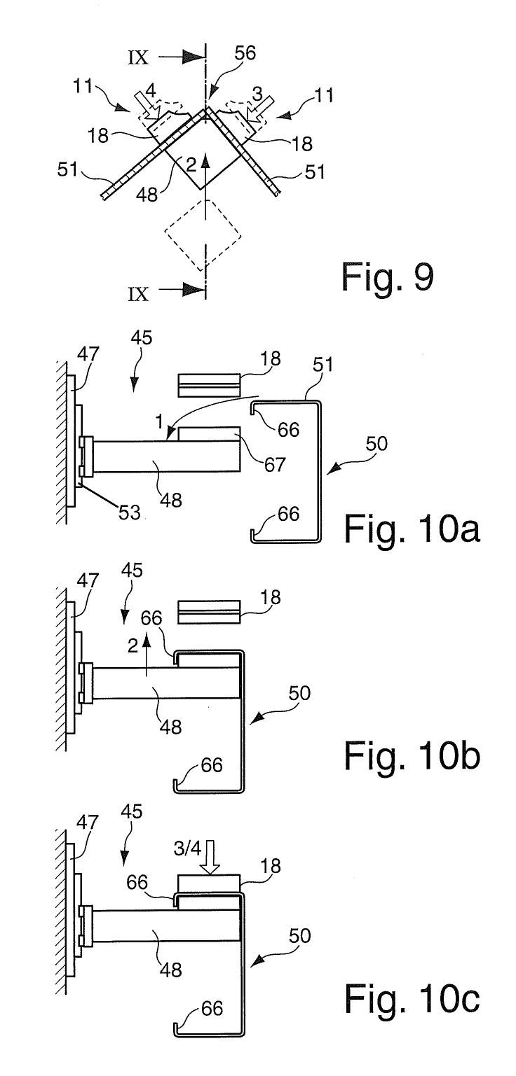

FIG. 9 and FIGS. 10a through 10c present a schematic sequence of individual work steps 1 through 4 for the clamping of a container 50 which has folded edges 66 on its upper lateral edges which point to the container center. Auxiliary clamping elements 67 can be mounted on the accommodating pin 48 for the accommodation of such containers 50 or components 51 with a folded edge 66. The auxiliary clamping elements for example can have a thickness corresponding to the width of the folded edge 66. As a result, the component 51 can be mounted on the accommodating pin 48, wherein the lateral wall of the container 50 lies on the auxiliary clamping element 47 and is held under tension with the clamping module 11 so that the front sides of the lateral walls for the formation of a joint 56 are firmly positioned to one another.

In step 1 the accommodating pin 48 is moved downward by the centering device 53 to mount the container 50, as shown in FIG. 10a. Then in step 2 the accommodating pin 48 is moved to a clamping position (FIG. 10b) so that in step 3 (FIG. 10c) and as shown in FIG. 9 first the right clamping module 11 is subjected to clamping force and then in step 4 the left clamping module 11 is likewise subjected to a clamping force. After that, a welding seam can be placed along the joint 56.

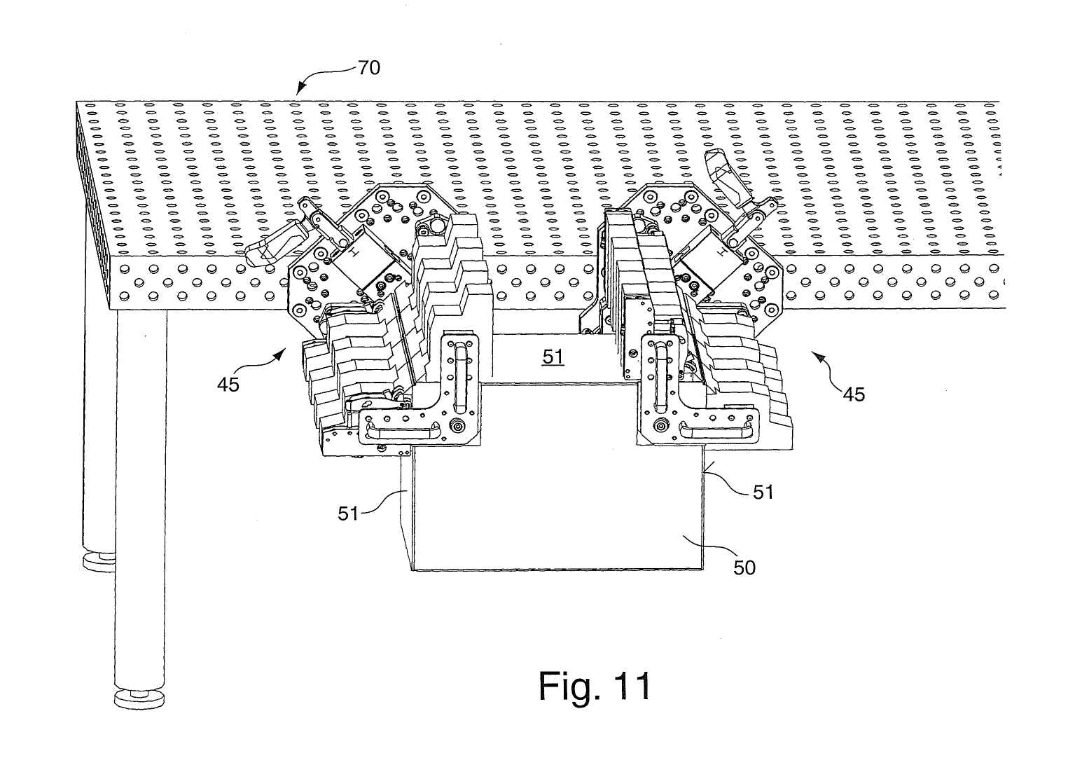

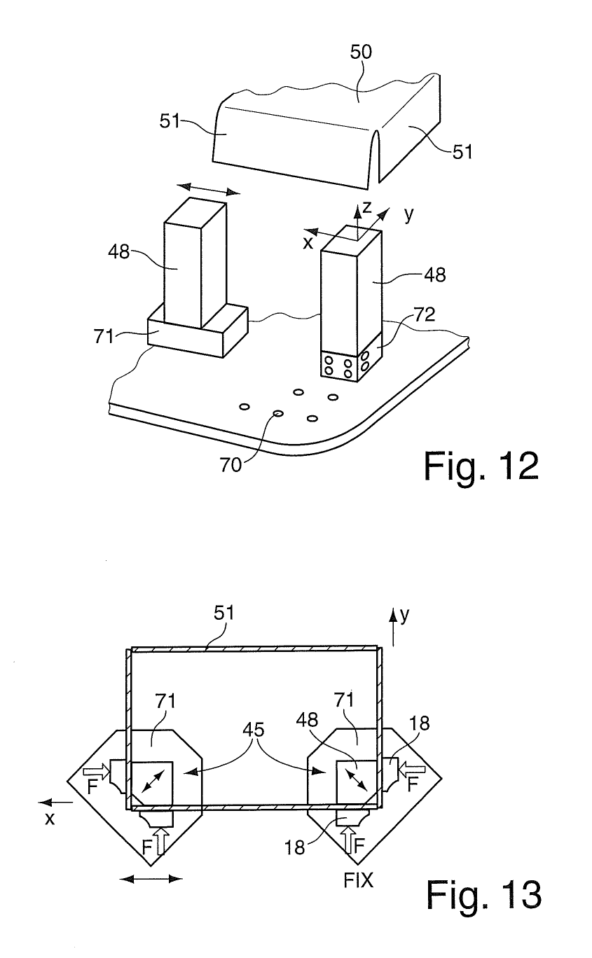

FIG. 11 presents a perspective view and FIG. 13 a schematic top view of two clamping devices 45 arranged at a work bench 70 (e.g., at a so-called Demmeler table. Through the arrangement of two clamping devices 45 at a distance to one another two edges of the container 50 can be clamped simultaneously. As shown in FIG. 12, one clamping device 45 can be fixed directly to the work bench 70 with an adapter element 72 or adapter plate, while the other clamping device 45 can be fastened via a linear module 71 on the work bench 70. This linear module 71 typically has an adjustment track in an axis of the assembly plane of the work bench which is constructed smaller or the same size as a perforation of the work bench 70. As a result, an exact adjustment of the two clamping devices 45 for the clamping of two edges of the container 50 can be set. This makes possible an efficient production of such components.

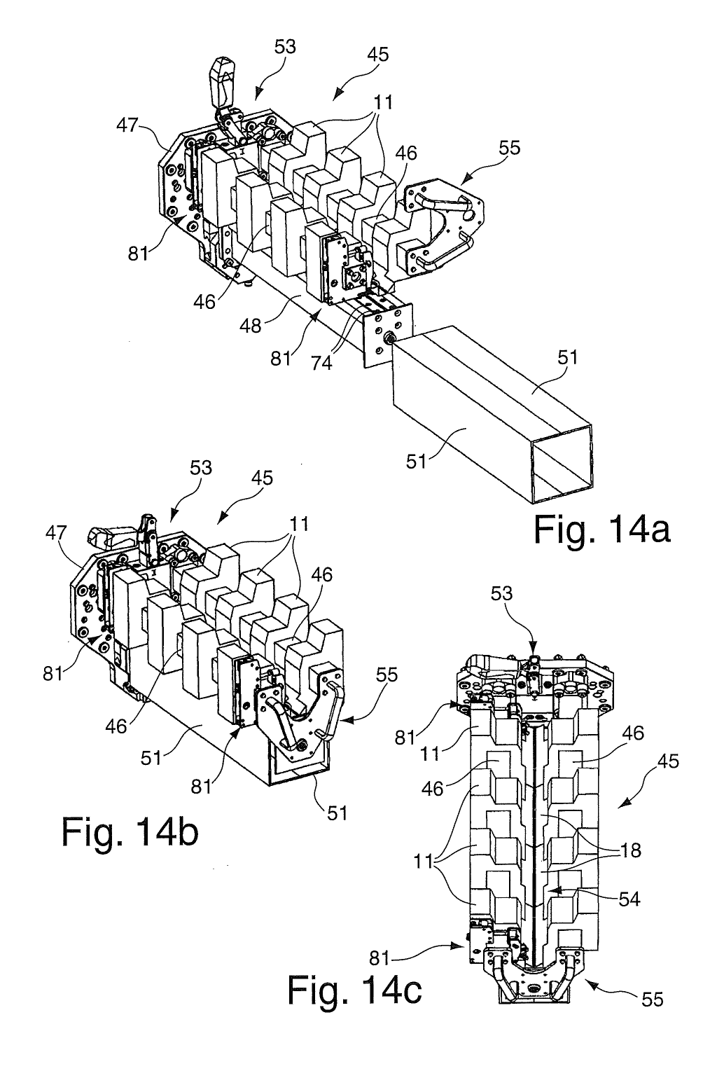

FIGS. 14a through 14c show perspective views of a clamping device 45 which is for the clamping of components 51 for the formation of tubular devices. FIG. 14a shows the clamping device 45 in a fitting position. In this position the accommodating pin 48 is adapted to the inner contour of the sheet metal parts 51 to be accommodated or corresponding auxiliary clamping elements 67 are arranged thereupon. In addition, in this exemplary embodiment of the accommodating pin 48 openings 74 pointing to the component 51 are shown, through which supply of a shielding gas is possible. After the insertion of the first and second components 51 for positioning on the accommodating pin 48, the mounting device 55 is positioned to the accommodating pin 48 and additional clamping beams 46, as shown in FIG. 14b. Then the left clamping module 11 and following that the right clamping module 11 or vice versa is supplied with the clamping stroke 19. Through the clamping jaws 18 adjacent to one another a continuous gap 54 can be created, as shown in FIG. 14c.

For exact positioning of the component or components 51 on the accommodating pin 48 typically positioning modules 81 can be positioned on the clamping beam 46 and assigned to a respective end of the component 51 to be placed upon the accommodating pin 48. This can be seen in FIGS. 14a and 14c. The clamping modules 11 are arranged between the positioning modules 81. In the process it is sufficient if the positioning modules 81 are arranged on one of the two clamping beams 46.

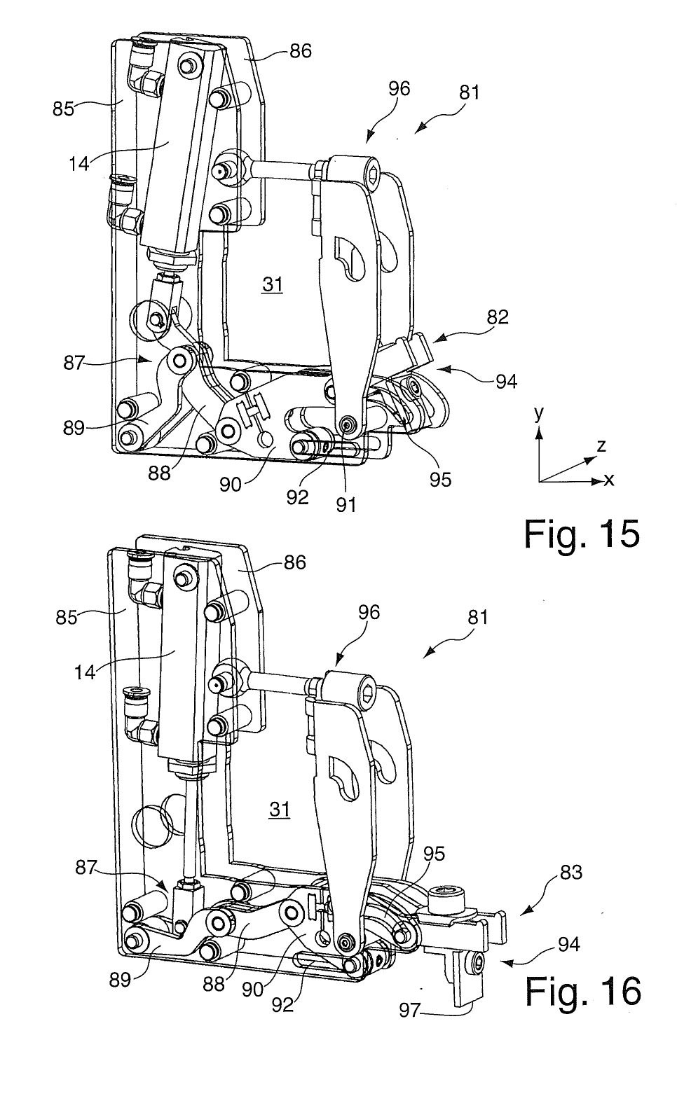

FIG. 15 shows a perspective view of the positioning module 81 in a starting position 82 and FIG. 16 shows the positioning module in an alignment position 83.

The positioning module 81 includes a housing which is constructed from a front and rear wall sections 85, 86. Lying in between is a path generation element which actuates a lever mechanism 87. This lever mechanism 87 can be constructed as a knee lever. A push rod or a connection rod 88 is pivotably attached on a pivot lever 89. In the case of a lifting movement of the path generation element 14, the push rod or connection rod 88 is moved in the X direction in accordance with FIG. 15, wherein simultaneously a sliding and pivoting element 90 is moved in the X direction. This sliding and pivoting element 90 can be moved back and forth in a slot 92 in the wall sections 85, 86. Simultaneously in the case of a thrust movement of the push rod or connection rod 88 an alignment element 94 along a further slot 95 in the sliding and pivoting element 90 is actuated so that it is transferred from the starting position 82 to the alignment position 83. The wall sections 85, 86 include a positioning opening 31, wherein the positioning opening is bordered by at least three front sides on the wall sections 85, 86. A clamping element 96 is on the upper end of the positioning opening 83, through which the width of the positioning opening 31 can be changed after the placement of the positioning module 81 on the clamping beam 46 by clamping the clamping element 96 to fix the positioning module 81 in its position to the clamping beam 46.

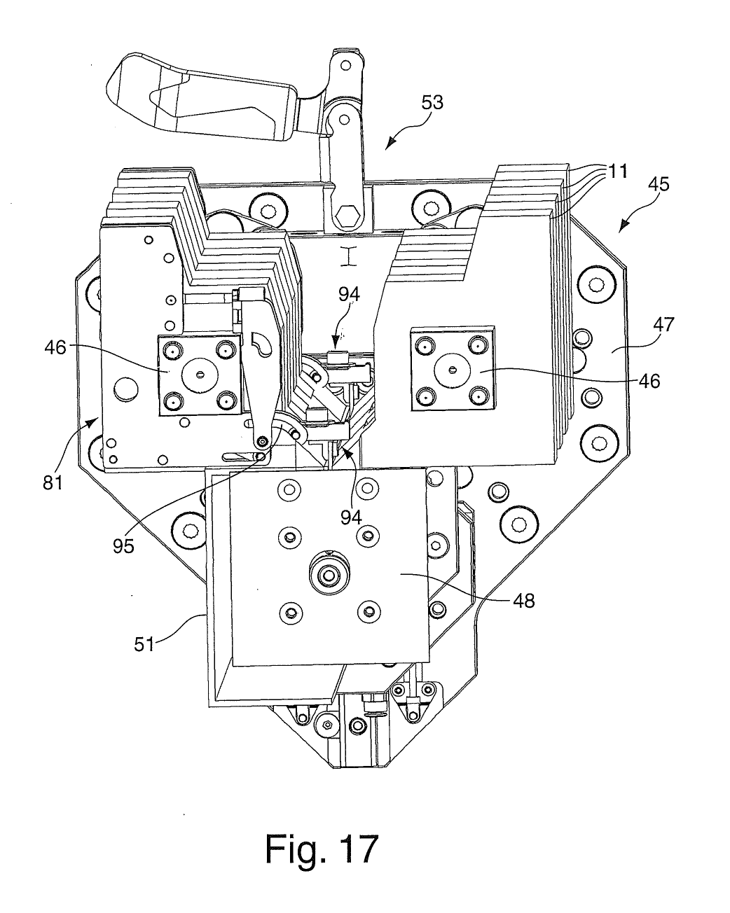

FIG. 17 shows a schematically enlarged view of the clamping device 45 in accordance with FIG. 14c, from which the function of the positioning module 81 arises and is discussed. The mounting device 55 is not shown in this representation.

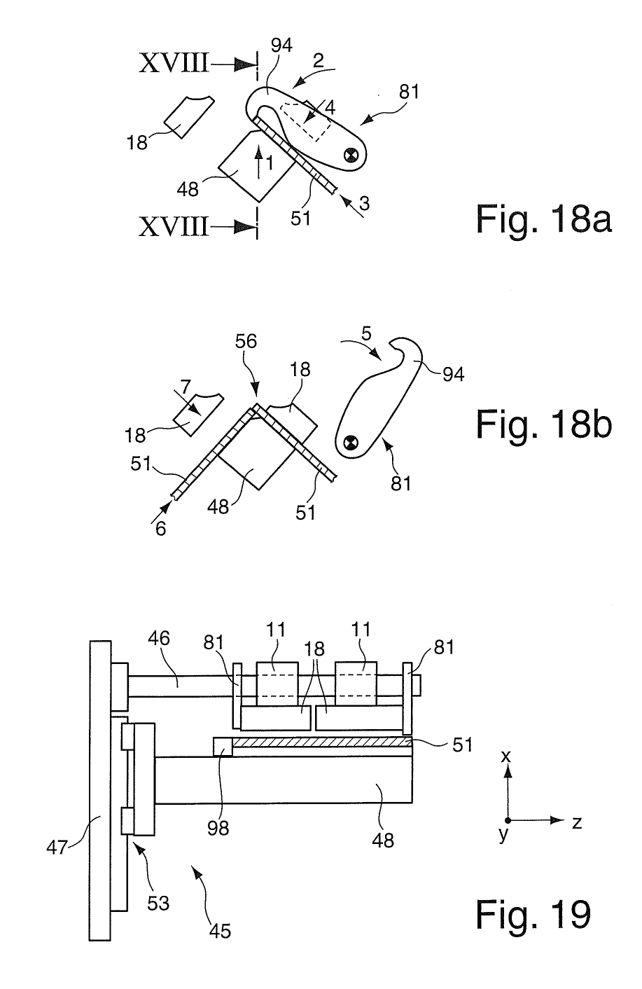

Prior to the insertion of the component 51, the positioning modules 81 are transferred from the starting position 82 to the alignment position 83. In the process, the alignment element 94 is guided along the slot 95. As a result, the alignment element 94 can during the approach movement overlap from the starting position 82 to the alignment position 83 the clamping jaw 18 so that a front side 97 of the alignment element 94 reaches the accommodating pin 48 and simultaneously there is a space saving arrangement of the positioning module 81 to the clamping module 11. Typically the clamping jaw 18 is designed to be wider than the positioning module 81. Then the component 51 is brought into contact with the two alignment elements 94 of the positioning module 81 on the accommodating pin 48 and after that the clamping modules 11 assigned to the component 51 are actuated. After the clamping of the component 51 by the clamping modules 11, the positioning modules 81 are moved back to a starting position 82. This transition is shown schematically in FIGS. 18a and 18b. Then the further component 51 is positioned for contact with the first component 51 for the formation of the joint 56, so that subsequently the opposing series of clamping modules 11 are actuated for the carrying out of a clamping movement.

Since the first component 51 is positioned in the correct position to the accommodating pin 48 via the positioning modules 81, no further positioning via the positioning modules 81 is required for the further component 51, but rather only for contact with the first component 51.

FIG. 19 shows a schematic lateral view of a basic embodiment of the clamping device 45 in accordance with FIGS. 14a through 14c. In addition a stop element 98 can be on the accommodating pin 48, to limit a path for the component 51 in the longitudinal axis of the accommodating pin 48 (the Z direction). This stop element 98 can be moved and positioned along the accommodating pin 48 and can also be removed if necessary. As a result, an exact positioning of two components 51 facing one another can take place, the components not yet being connected by a further component section.

The foregoing described clamping device 45 with the clamping modules 11 which can be arranged on the clamping beams 46 and which can be assigned to the accommodating pin 48 makes possible the construction of a modular clamping device 45 for the production of linear welding edges, through which different components, housings, containers or the like can be clamped in a distinct position for the production of the welding seam. In addition, via the clamping modules 11 a sensory query is made possible as to whether the component or components 51 are present or whether the clamping modules 11 have occupied the clamping states. As a result, a higher degree of automation can be achieved.

A number of embodiments have been described. Nevertheless, it will be understood that various modifications may be made without departing from the spirit and scope of the invention. Accordingly, other embodiments are within the scope of the following claims.

What is claimed is:

1. A clamping module for a clamping device comprising:
a housing;
a drive device in the housing the drive device being configured to move at least one clamping jaw from a starting position to a clamping position; and
at least one solid body joint between the drive device and the at least one clamping jaw, the at least one solid body joint being elastically resilient in a direction of a clamping movement of the at least one clamping jaw.

2. The clamping module according to claim 1, wherein the at least one solid body joint is rigid in a direction of movement transverse to the direction of the clamping movement.

3. The clamping module according to claim 1, wherein the housing accommodates a mechanism and the solid body joint is arranged between the mechanism and the at least one clamping jaw, and wherein the drive device and the mechanism transfer the at least one clamping jaw from a starting position to a clamping position.

4. The clamping module according to claim 3, wherein at least two mechanisms are arranged next to one another and actuated with the drive device to jointly engage the at least one clamping jaw.

5. The clamping module according to claim 3, wherein a reset element engages the mechanism near the drive device, the reset element being configured to reset the mechanism to a starting position in a non-impacted state of the drive device and move the at least one clamping jaw to a starting position.

6. The clamping module according to claim 3, wherein the mechanism comprises at least one push rod or connection rod connected via a joint to at least one clamping lever of a clamping mechanism, the at least one clamping jaw being connectable to an end of the at least one clamping lever opposite the joint.

7. The clamping module according to claim 6, wherein the solid body joint is in a single piece on the at least one clamping lever.

8. The clamping module according to claim 6, wherein the at least one clamping lever is pivotable around a stationary pivoting axis arranged on the housing.

9. The clamping module according to claim 6, wherein the at least one clamping jaw is exchangeable by a snap, tension, snap-on or clamped connection on the at least one clamping lever of the mechanism.

10. The clamping module according to claim 6, wherein the housing comprises a right and a left wall section each with a positioning opening for plug-on arrangement of the housing on a clamping beam of a clamping device, wherein the position openings align with one another and the at least one lever mechanism is guided at least along one exterior of the positioning opening.

11. A positioning module for a clamping device, comprising:
a housing;
a drive device in the housing;
a mechanism operably connected to the drive device; and
an alignment element configured to be actuated by the mechanism such that the alignment element can be moved from a starting position to an alignment position with a sliding-pivoting movement.

12. The positioning module according to claim 11, wherein the mechanism is a lever mechanism which actuates a sliding and pivoting element that is guided in the housing.

13. The positioning module according to claim 12, wherein the sliding and pivoting element is guided longitudinally through a slot in the housing and the alignment element is guided through a further slot in the pivoting and sliding element.

14. The positioning module according to claim 11, wherein the housing comprises a right and a left wall section in which a positioning opening is provided for plug-on arrangement of the housing on a clamping beam of a clamping device in both wall sections.

15. A clamping device for the clamping of at least one component for a subsequent welding operation with at least one clamping module according to claim 1 and at least one positioning module according to claim 11,
wherein an accommodating pin and at least two clamping jaws are arranged freely projecting on a base plate,
at least two clamping jaws and the accommodating pin are positioned in triangular arrangement to one another on the base plate,
at least one clamping module is arrangeable on each clamping beam, and
the at least one clamping jaw of the clamping module arranged on the clamping beam is assigned to the accommodating pin for fixing the component to the accommodating pin.

16. The clamping device according to claim 15, wherein the clamping modules are arranged mirror-imaged to the accommodating pin on the clamping beam and the clamping jaws face one another and form a gap to fix the components with one joining edge to the accommodating pin.

17. The clamping device according to claim 15, wherein one or more clamping modules are arranged on the same clamping beam and are movable along the clamping beam.

18. The clamping device according to claim 17, wherein the housing of the clamping module is connected to the clamping beam.

19. The clamping device according to claim 15, wherein the clamping beam comprises a cross-section geometry which with a complementary positioning opening in the housing of the clamping module forms an anti-turn accommodation of the clamping module to the clamping beam.

20. The clamping device according to claim 15, wherein the accommodating pin and/or the at least one clamping beam are fastened on the base plate with a centering device.

21. The clamping device according to claim 20, wherein the centering device comprises centering blocks which apply bending moments of the clamping beam to the base plate.

22. The clamping device according to claim 15, wherein the at least one positioning module is arrangeable on the clamping beam, the positioning module being movable along the longitudinal axis of the clamping beam.

23. The clamping device according to claim 15, wherein a stop element is arrangeable on the clamping beam or on the accommodating pin, the stop element being moveable along the longitudinal axis of the clamping beam or of the accommodating pin.

24. The clamping device according to claim 15, wherein at least one auxiliary clamping element for the accommodation of at least one component with at least one angle of bend or one folded edge is detachably fastened on the accommodating pin.

25. The clamping device according to claim 15, wherein the accommodating pin comprises at least one channel assigned to a welding edge of at least one component for the supply of at least one of a welding gas or a cooling medium.
